(19) United States
(12) Patent Application Publication
(10) Pub. No.: US 2010/0157939 A1
(43) Pub. Date: Jun. 24, 2010

(54) CROSSOVER NODE DETECTION PRE-PROCESSING METHOD, CROSSOVER NODE DETECTION PRE-PROCESSING PROGRAM FOR EXECUTING THIS METHOD BY COMPUTER, AND MOBILE TERMINAL USED IN THIS METHOD

(75) Inventors: Toyoki Ue, Kanagawa (JP); Takako Hori, Kanagawa (JP); Takashi Aramaki, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co., Ltd., Osaka (JP)

(21) Appl. No.: 11/997,693

(22) PCT Filed: Aug. 3, 2006
(86) PCT No.: PCT/JP2006/315373

§ 371 Date: Feb. 1, 2008

(30) Foreign Application Priority Data
Aug. 3, 2005 (JP) 2005-225998
Jul. 28, 2006 (JP) 2006-207188

(51) Int. Cl. H04W 36/00

(52) U.S. Cl. 370/331

(57) ABSTRACT

A technology is disclosed providing a crossover node detection pre-processing method and the like in which, when a MN performs a handover and detects a CRN, a layer, among an aggregation overlapping such as to be nested (a plurality of network layers), up to which a process for detecting the CRN is performed is decided and a number of layers from the outermost layer of the aggregation to the decided layer is decided. As a result, the CRN detection is not time-consuming, double reservation can be kept to a minimum, and QoS failure can be avoided. The technology includes a step of deciding, by a mobile node 10, a network layer, among a plurality of network layers overlapping such as to be nested, up to which the process for detecting the CRN is performed and deciding a number of layers from the outermost network layer of the plurality of network layers to the decided network layer, and a step of generating a message including information on the decided number of layers.

### TECHNICAL FIELD

The present invention relates to a crossover node detection pre-processing method, a crossover node detection pre-processing program for executing this method by a computer, and a mobile terminal used in this method, in which the crossover node detection pre-processing method is used in a handover performed by a mobile terminal (mobile node) performing wireless communication. In particular, the present invention relates to a crossover node detection pre-processing method, a crossover node detection pre-processing program for executing this method by a computer, and a mobile terminal used in this method, in which the crossover node detection pre-processing method is used in a handover performed by a mobile node performing wireless communication using mobile Internet Protocol version 6 (IPv6), which is a next-generation Internet protocol.

### BACKGROUND ART

A technology using mobile IPv6, which is a next-generation Internet protocol, is becoming popular as a technology for providing seamless communication network connection to a user accessing a communication network, such as the Internet, from a mobile node via a wireless network, even while the user is moving. The wireless communication system using the mobile IPv6 will be described with reference to FIG. 11. A technology using the mobile IPv6 described hereafter is, for example, disclosed in Non-Patent Document 1.

The wireless communication system shown in FIG. 11 includes an IP network (communication network) 15, a plurality of subnets (also referred to as subnetworks) 20 and 30, and a mobile terminal (mobile node [MN]) 10. The IP network is, for example, the Internet. The subnets 20 and 30 are connected to the IP network 15. The mobile terminal 10 can be connected to any of the plurality of subnets 20 and 30. In FIG. 11, two subnets, subnet 20 and subnet 30, are shown as the plurality of subnets.

The subnet 20 includes an access router (AR) 21 and a plurality of access points (AP) 22 and 23. The AR 21 performs routing of IP packets (packet data). The AP 22 and 23 respectively form fixed wireless-covered areas (areas in which communication is possible) 28 and 29. The AP 22 and 23 are each connected to the AR 21. The AR 21 is connected to the IP network 15. In FIG. 11, two access points, AP 22 and AP 23, are shown as the plurality of AP. The subnet 30 is also configured to be connected in the same manner as the subnet 20, described above, using an AR 31 and a plurality of AP 32 and 33.

The AR 21, which is a constituent element of the subnet 20, and the AR 31, which is a constituent element of the subnet 30, can communicate via the IP network 15. In other words, the subnet 20 and the subnet 30 are connected by the IP network 15.

In the wireless communication system shown in FIG. 11, the MN 10 starts wireless communication with the AP 23 within the wireless-covered area 29. At this time, when an IPv6 address assigned to the MN 10 is not suitable for an IP address system of the subnet 20, the MN 10 present in the wireless-covered area 29 acquires an IPv6 address suitable for the subnet 20, via the wireless communication performed with the AP 23. In other words, the MN 10 acquires a Care of Address (CoA).

Following methods exist as a method by which the MN 10 acquires the CoA. The CoA can be assigned statefully by a dynamic host configuration protocol (DHCP) server, through use of a DHCPv6 method or the like. Alternatively, a network prefix and a prefix length of the subnet 20 can be acquired from the AR 21. In the MN 10, the network prefix and the prefix length acquired from the AR 21 can be combined with a link layer address or the like of the MN 10. The CoA can be automatically generated statelessly.

Then, the MN 10 registers (binding update [BU]) the acquired CoA in a router (home agent) in a home network of the MN 10 itself and a certain communication partner (correspondent node [CN]). As a result, transmission or reception of packet data becomes possible within the subnet 20.

As a result, the packet data transmitted to the MN 10 from a predetermined communication partner is transmitted to the MN 10 via the AR 21 and the AP 23, based on the CoA of the MN 10. At the same time, the packet data transmitted by the MN 10 to a desired communication partner is transmitted to the desired communication partner via the AP 23 and the AR 21. In addition, packet data addressed to the MN 10 that is transmitted to the home network is also sent to the AR 21 of the subnet 20, based on the CoA of the MN 10 registered the home agent. The packet data is then transmitted to the MN 10, via the AP 23.

As described above, the wireless communication system using the mobile IPv6, shown in FIG. 11, is configured such that the MN 10 can continue wireless communication using the CoA, even when the MN 10 performs a handover from a certain subnet to another subnet. For example, a fast handover technology disclosed in Non-Patent Document 2, described below, is known as a technology for increasing the speed of the handover process.

In the fast handover technology, before the MN 10 performs a L2 handover, the MN 10 acquires a new CoA (referred to, hereinafter, as NCoA) to be used in the subnet 30, in advance. A tunnel can be generated between the AR 21 and the AR 31 by the AR 21 being notified of the NCoA. Even from when the MN 10 performs the L2 handover and switches connection from the AP 23 to the AP 32 until the MN 10 moves to the subnet 30 and officially registers (BU) the NCoA acquired in advance, the packet data sent addressed to the previous CoA (referred to, hereinafter, as PCoA) of the MN 10 used in the subnet 20 can be transferred to the MN 10 through the tunnel, via the AR 31 and the AP 32. In addition, the packet data transmitted from the MN 10 also reaches the AR 21 through the tunnel, via the AP 32 and the AR 31, and is sent from the AR 21 to the communication partner.

At the same time, services such as a Quality of Service (QoS) guarantee are provided for communication using the network (service such as this are referred to, in the present specification, as additional services). Various communication protocols exist to realize these additional services. Among these various communication protocols, for example, a Resource Reservation Protocol (RSVP) can be given as a protocol for guaranteeing QoS (refer to, for example, Non-Patent Document 3, described below). In the RSVP, a bandwidth reservation is made on a path (flow) from a transmission-side communication node performing data transmission to a reception-side communication node performing data reception. Data can be transmitted smoothly from the transmission-side communication node to the reception-side communication node.

Regarding the MN 10 performing the handover between the subnet 20 and the subnet 30, a demand is made that the additional services, such as the QoS guarantee, received before the handover be continuously received even after the handover. However, the above-described RSVP cannot meet the above-mentioned demand, particularly regarding the points described below. The RSVP cannot support movement of the MN 10. FIG. 12 is a schematic diagram explaining that the RSVP in a conventional technology cannot support the movement of the MN.

In the RSVP, a QoS path is set in an end-to-end path from a communication partner node 60 of the MN 10 to the MN 10. A plurality of relay nodes 61 connected along the end-to-end path perform data transfer based on the addresses of the MN 10 and the CN 60. Therefore, when, for example, the MN 10 performs a handover between the subnet 20 and the subnet 30 and the CoA of the MN 10 changes, a process related to the address change is required to be performed on the QoS path, in addition to a flow change. The RSVP cannot support changes such as this. As a result, the QoS guarantee fails (first problem: difficulty in changing QoS path). Even when a new QoS path is set, when a section is formed at which the QoS paths before and after the handover overlap, a double resource reservation (double reservation) may occur in the overlapping section (second problem: double resource reservation).

To solve such problems, the Internet Engineering Task Force (IETF) is currently discussing standardization of a new protocol called Next Steps in Signaling (NSIS) (refer to Non-Patent Document 4, below). The NSIS is expected to have a particularly positive effect on various additional services, such the QoS guarantee, in a mobile environment. Documents describing conditions and realization methods for realizing the QoS guarantee and mobility support through the NSIS are available (refer, for example, to Non-Patent Documents 5 to 11, below). Hereafter, an overview of the NSIS that is a draft specification by the NSIS Working Group of the IETF and a method of establishing a QoS path are described (refer to Non-Patent Document 6 and Non-Patent Document 9).

FIG. 13 is a diagram of a protocol stack of the NSIS and its lower layers for explaining a NSIS protocol configuration according to a conventional technology. The NSIS protocol layer is positioned directly above the IP and the lower layers. The NSIS protocol layer includes two layers, a NSIS signaling layer protocol (NSLP) and a NSIS transport layer protocol (NTLP). The NSLP generates a signaling message for providing respective additional services and processes the signaling message. The NTLP performs routing of the signaling message generated by the NSLP. Various NSLP are provided, such as a NSLP for QoS (QoS NSLP) and NSLP for other certain additional services (service A and service B) (NSLP of service A and NSLP of service B).

FIG. 14 is a schematic diagram explaining a concept of a NE and a QNE being “adjacent”. NE and QNE are NSIS nodes according to the conventional technology. As shown in FIG. 14, all nodes having a NSIS function (NSIS Entity [NE]) include at least the NTLP. The NSLP is not necessarily required to be present above the NTLP. Alternatively, one or more NSLP can be present above the NTLP. Here, the NE supporting the NSLP for QoS is particularly referred to as the QoS NSIS Entity (QNE). A node or a router can be the NE. A plurality of routers that are not the NE can be present between adjacent NE. In addition, a plurality of routers that are not the NE and a plurality of NE that do not support the QoS NSLP can also be present between adjacent ONE.

Next, an example of a conventional QoS path establishing method (QoS resource reservation) will be described with reference to FIG. 15. The MN 10 connected to the AR 21 in the subnet 20 is scheduled to receive data or is (currently) receiving data from the CN 60 for a certain purpose (session). When establishing the QoS path, the MN 10 transmits a RESERVE message for establishing the QoS path to the CN 60. The RESERVE message includes information (Qspec) on the QoS desired for receiving data from the CN 60. The transmitted RESERVE message reaches a QNE 63, via the AR 21, a NE 62, and a router (not shown) that has no other NSIS functions. The NSLP of the QNE 63 reserves the QoS resource stated in the Qspec, included in the RESERVE message, for the session. Furthermore, the RESERVE message that has passed through the QNE 63 reaches a QNE 65, via a NE 64 and a router (not shown) that has no other NSIS functions. The same process as that for the QNE 63 is performed for the QNE 65, as well, and the QoS resource is reserved. The operation is repeated. The QoS path is established between the MN 10 and the CN 60 by the RESERVE message finally being sent the CN 60.

To identify the resource reservation, a flow identifier and a session identifier are used. The flow identifier is dependent on the CoA of the MN 10 and the IP address of the CN 60. The QNE 63 and the QNE 65 each confirm the IP addresses of the transmission source and the transmission destination of each data packet, thereby finding out whether a resource reservation has been made for the data packet. When the MN 10 moves to another subnet and the CoA changes, the flow identifier also changes depending on the change in CoA of the MN 10. On the other hand, the session identifier is used to identify a series of data transmissions for a session. The session identifier does not change with the handover of the terminal, unlike the flow identifier.

A procedure called QUERY is used as a method of checking for the possibility of obtaining a QoS resource and the like for an arbitrary path. This method is, for example, used to check whether, when a QoS path is established from the MN 10 to the CN 60, a desired Qspec can be reserved at each QNE. A QUERY message used to check whether the desired Qspec can be reserved at each QNE is transmitted. The result can be received by a RESPONSE message that is a response to the QUERY message. The current resource reservation state never changes as a result of the QUERY and RESPONSE messages. The QNE can use a NOTIFY message to give a notification of some kind to another QNE. The NOTIFY message is, for example, used for error notification. The above-described RESERVE, QUERY, RESPONSE, and NOTIFY messages are all NSLP messages for QoS guarantee and are described in Non-Patent Document 6.

Next, a method of avoiding a double resource reservation when the MN 10 moves from the subnet 20 to the subnet 30 in the conventional technology will be described with reference to FIG. 16. When the MN 10 is receiving data from the CN 60 and the QoS path (path 24) is established, the QoS resources desired by the MN 10 are reserved at each of the QNE 63, the QNE 65, and the QNE 66. The flow identifier and the session identifier at this time are respectively X and Y. In actuality, the flow identifier X includes the current IP address of the MN 10 and the IP address of the CN 60, as described above. The session identifier Y is set to a sufficiently large arbitrary value. In this state, the MN 10 sends a RESERVE message for establishing a new QoS path to the CN 60 after handover to the subnet 30. The previous path (path 24) is not freed immediately after the handover of the MN 10.

As described above, the flow identifier changes with the handover of the MN 10. Therefore, the flow identifier X of the path 24 and the flow identifier of a path 34 (the flow identifier of the path 34 is Z) differ. The QNE 67 has no resource reservation for the session identifier Y in any interface. Therefore, the QNE 67 judges that a new path establishment is being performed. The QNE 67 makes the resource reservation for the flow identifier Z and the session identifier Y. At the same time, the resource reservation is made for the session identifier Y at the QNE 65 and the QNE 66. Here, as a result of the QNE 65 and the QNE 66 comparing the flow identifiers and recognizing that the flow identifier has changed from X to Z, the QNE 65 and the QNE 66 judge that a new path is being established in accompaniment to the handover of the MN 10. To avoid double resource reservation, a procedure such as updating a previous reservation without making a new resource reservation is performed. The QNE at which the previous path and the new path begin to merge is referred to as a crossover node (CRN). The CRN can indicate a router at which the paths actually begin to merge (NE 64 in FIG. 16). However, when discussing the QoS path, the CRN indicates a QNE (QNE 65 in FIG. 16) of which, on the previous path (path 24) and the new path (path 34), an adjacent QNE (QNE 66 in FIG. 16) on one side is the same and the adjacent QNE (QNE 63 and QNE 67 in FIG. 16) on the other side differ.

In this way, the CRN serves an important role in avoiding double resource reservation when a handover is performed. Therefore, finding the CRN is one of the important problems regarding the handover.

To reduce signaling and the like within the network, aggregation of reservations in multiple flows (nested aggregation) can be considered. FIG. 17 is an example of a nested aggregation reservation. Flow reservation between the CN 60 and the MN 10 (end-to-end) is started normally. An aggregator starts a nested aggregation flow reservation. The aggregator serves as a QoS NSIS Initiator (QNI) in the nested aggregation reservation. The aggregator has a flow ID for the nested aggregation reservation (for example, a tunnel) instead of an individual flow reservation. In the nested aggregation reservation, a marking is used such that an intermediate router is not required to check individual flow reservations. A deaggregator is the next QNE of the flow reservation in the end-to-end. The deaggregator serves as a QoS NSIS Responder (QNR) in the nested aggregation reservation.

Non-Patent Document 1: D. Johnson, C. Perkins and J. Arkko, “Mobility Support in IPv6”, draft-ietf-mobileip-ipv6-24, June 2003
Non-Patent Document 2: Rajeev Koodli “Fast Handovers for Mobile IPv6”, draft-ietf-mobileip-fast-mipv6-08, October 2003

### Non-Patent Document 3: R. Braden, L. Zhang, S. Berson, S. Herzog and S. Jamin, “Resource ReSerVation Protocol—Version 1 Functional Specification”, RFC 2205, September 1997

Non-Patent Document 4: NSIS WG http://www.ietf.org/html.c harters/nsis-charter.html)

### Non-Patent Document 5: H. Chaskar, Ed, “Requirements of a Quality of Service (QoS) Solution for Mobile IP”, RFC3583, September 2003

Non-Patent Document 6: Sven Van den Bosch, et al., “NSLP for Quality-of-Service signalling”,

draft-ietf-nsis-qos-nslp-05.txt, October 2004

Non-Patent Document 7: X. Fu, H. Schuizrinne, H. Tschofenig, “Mobility issues in Next Steps signaling”, draft-fu-nsis-mobility-01.txt, October 2003
Non-Patent Document 8: Roland Bless, et. Al., “Mobility and Internet Signaling Protocols”, draft-manyfolks-signaling-protocol-mobility-00.txt, January 2004
Non-Patent Document 9: R. Hancock et al., “Next Steps in Signaling: Framework”, draft-ietf-nsis-fw-07.txt, November 2004
Non-Patent Document 10: S. Lee, et al., “Applicability Statement of NSIS Protocols in Mobile Environments”, draft-ietf-nsis-applicability-mobility-signaling-00.txt, October 2004

### Non-Patent Document 11: M. Brunner (Editor), “Requirements for Signaling Protocols”, RFC3726, April 2004

Non-Patent Document 12: T. Ue, T. Sanda, K. Honma, “QoS Mobility Support with Proxy-assisted Fast Crossover Node Discovery”, WPMC2004, September 2004

A main difference between the example described in FIG. 17 and the example without the aggregator described above is that the flow ID in the nested aggregation reservation differs from the flow ID in the end-to-end reservation. The nested aggregation reservation can be updated independently from the end-to-end reservation. When the MN performs a handover and starts a CRN detection, the aggregator or the deaggregator detects a CRN as the CRN in the end-to-end reservation, though the actual CRN is present within the aggregation. In this case, double reservation occurs between the CRN in the end-to-end reservation and the actual CRN. The CRN detection is required to be performed up to the inside of the nested aggregation to prevent double reservation. However, time is required to perform a complete CRN detection in the nested aggregation, causing a delay in the QoS handover. As a result, a QoS failure occurs.

### DISCLOSURE OF THE INVENTION

The present invention has been achieved in light of the above-described problems. An object of the present invention is to provide a crossover node detection pre-processing method, a crossover node detection pre-processing program for executing this method by a computer, and a mobile node used in this method, that can, when the mobile node performs a handover and detects a CRN, decide a layer, among an aggregation overlapping such as to be nested plurality of layers), up to which a process for detecting the CRN is performed and decide a number of layers from an outermost layer of the aggregation (the plurality of layers) to the decided layer. As a result, the CRN detection is not time-consuming, double reservation can be kept to a minimum, and QoS failure can be avoided.

In order to achieve the object, a crossover node detection pre-processing method is provided. The crossover node detection pre-processing method acquires, in a communication system in which a plurality of access routers, each forming a subnet, are connected via a communication network configured such that a plurality of network layers are overlapped such as to be nested, and at least one access point forming a fixed communicable area is connected to each of the plurality of access routers, when a mobile node configured such as to communicate, by wireless communication with the access point within the communicable area, with the access router to which the access point is connected switches connection from a currently communicating access point to another access point as a result of handover, information required to detect a crossover node at which a new communication path and an old communication path in the communication network converge and separate. The crossover node detection pre-processing method includes a step of deciding, by the mobile node, a network layer, among the plurality of network layers overlapped such as to be nested, up to which a process for detecting the crossover node is performed and deciding a number of layers from an outermost network layer of the plurality of network layers to the decided network layer. The crossover node detection pre-processing method also includes a step of generating a message including information on the decided number of layers. As a result of the configuration, the CRN detection is not time-consuming, double reservation can be kept to a minimum, and QoS failure can be avoided. The network layer refers to an end-to-end layer and a nest layer, described hereafter. The network layer differs from a layer in an Open Systems Interconnection Basic Reference Model (OSI model). The OSI model is a communication function that should be included in a computer, divided into a hierarchical structure. Hereinafter, the network layer may be simply referred to as a layer.

In the crossover node detection pre-processing method of the present invention, a preferred aspect of the present invention is that the number of layers from the outermost network layer of the plurality of network layers to the decided network layer is decided by a managing device managing the communication network. As a result of the configuration, the number of layers can be decided by the communication network side.

In the crossover node detection pre-processing method of the present invention, a preferred aspect of the present invention is that the number of layers from the outermost network layer of the plurality of network layers to the decided network layer is decided based on at least a resource of the communication network, a policy of the communication network, and information on a QoS request. As a result of the configuration, a more suitable number of layers can be decided.

In the crossover node detection pre-processing method of the present invention, a preferred aspect of the present invention is that a number of the plurality of network layers overlapped such as to be nested that is a base when the process for detecting the crossover node is performed is detected based on a layer number detection message of which 1 is added to a nest count value indicating a number of upper network layers included in the layer number detecting message, when an edge node positioned on an edge of each network layer of the plurality of network layers that receives the layer number detection message for detecting the number of the plurality of network layers, transmitted by the mobile node, receives the layer number detection message. As a result of the configuration, the number of layers in the overall communication network can be known. The edge node positioned on the edge of the network layer refers to an aggregator or a deaggregator, described hereafter.

In the present invention, a crossover node detection pre-processing program is provided. The crossover node detection pre-processing program is for executing the crossover node detection pre-processing method, described in any of the inventions above, by a computer. As a result of the configuration, the CRN detection is not time-consuming, double reservation can be kept to a minimum, and QoS failure can be avoided.

In the present invention, a mobile terminal is provided. The mobile terminal is used in a crossover node detection pre-processing method for acquiring, in a communication system in which a plurality of access routers, each forming a subnet, are connected via a communication network configured such that a plurality of network layers are overlapped such as to be nested, and at least one access point forming a fixed communicable area is connected to each of the plurality of access routers, when the mobile node configured such as to communicate, by wireless communication with the access point within the communicable area, with the access router to which the access point is connected switches connection from a currently communicating access point to another access point as a result of handover, information required to detect a crossover node at which a new communication path and an old communication path in the communication network converge and separate. The mobile terminal includes a deciding means that decides a network layer, among the plurality of network layers overlapped such as to be nested, up to which a process for detecting the crossover node is performed and decides a number of layers from an outermost network layer of the plurality of network layers to the decided network layer. The mobile terminal also includes a message generating means that generates a message including information on the decided number of layers. As a result of the configuration, the CRN detection is not time-consuming, double reservation can be kept to a minimum, and QoS failure can be avoided.

in the mobile node of the present invention, a preferred aspect of the present invention is that the deciding means decides the number of layers from the outermost network layer of the plurality of network layers to the decided network layer based on at least a resource of the communication network, a policy of the communication network, and information on a QoS request. As a result, a more suitable number of layers can be decided.

In the mobile node of the present invention, a preferred aspect of the present invention is that a number of the plurality of network layers overlapped such as to be nested that is a base when the process for detecting the crossover node is performed is detected based on a layer number detection message of which 1 is added to a nest count value indicating a number of upper network layers included in the layer number detecting message, when an edge node positioned on an edge of each network layer of the plurality of network layers that receives the layer number detection message for detecting the number of the plurality of network layers, generated by the message generating means, receives the layer number detection message. As a result of the configuration, the number of layers of the overall communication network can be known.

The crossover node detection pre-processing, method, the crossover node detection pre-processing program for executing this method by a computer, and the mobile node used in this method of the present invention have the above-described configurations. When the mobile node performs a handover and the CAN is detected, the network layer, among the aggregation overlapping such as to be nested the plurality of network layers), up to which the process for detecting the CRN is performed is decided and the number of layers from the outermost network layer of the aggregation to the decided network layer is decided. As a result, the CRN detection is not time-consuming, double reservation can be kept to a minimum, and QoS failure can be avoided.

### BRIEF DESCRIPTION OF THE DRAWINGS

FIG. 1 is a schematic diagram of a configuration of a communication network according to an embodiment of the present invention;

FIG. 2 is a schematic diagram of a nested aggregation reservation in the communication network according to the embodiment of the invention;

FIG. 3 is a schematic diagram of a configuration of a mobile node according to the embodiment of the invention;

FIG. 4 is a flowchart explaining a flow of a crossover node detection pre-processing according to the embodiment of the invention;

FIG. 5 a sequence chart explaining an example of a CRN detection in a new upstream link path according to the embodiment of the invention;

FIG. 6 is a sequence chart explaining an example of a state reservation procedure using QUERY and RESERVE messages according to the embodiment of the invention;

FIG. 7 is a sequence chart explaining an example of a method of detecting the number of layers in the communication network according to the embodiment of the invention;

FIG. 8 is a sequence chart explaining an example of another method of detecting the number of layers in the communication network according to the embodiment of the invention;

FIG. 9 is a sequence chart explaining an example of another method of detecting the number of layers in the communication network according to the embodiment of the invention;

FIG. 10 is a sequence chart explaining an example of another method of detecting the number of layers in the communication network according to the embodiment of the invention;

FIG. 11 is a schematic diagram of a configuration of a wireless communication system common to both the present invention and a conventional technology;

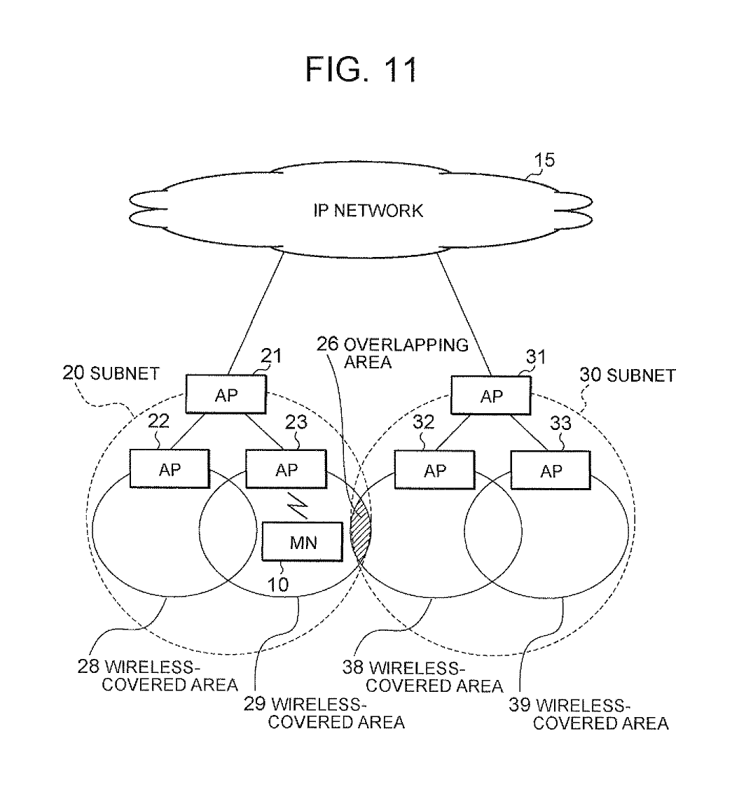

FIG. 12 is a schematic diagram explaining that RSVP in the conventional technology does not support movement of MN;

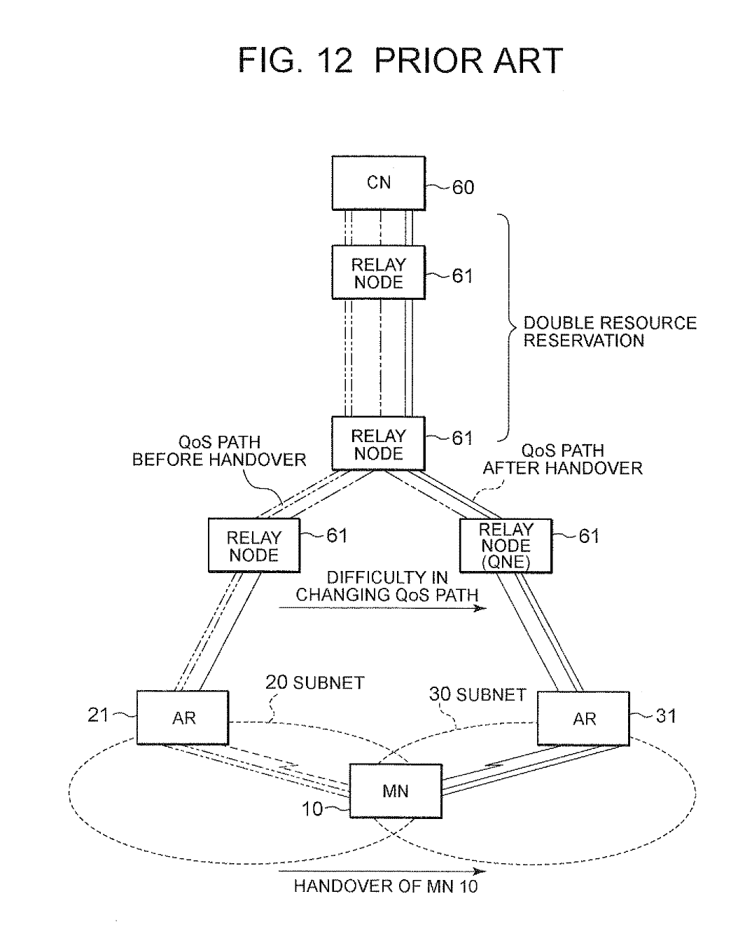

FIG. 13 is a schematic diagram explaining a NSIS protocol configuration in the conventional technology;

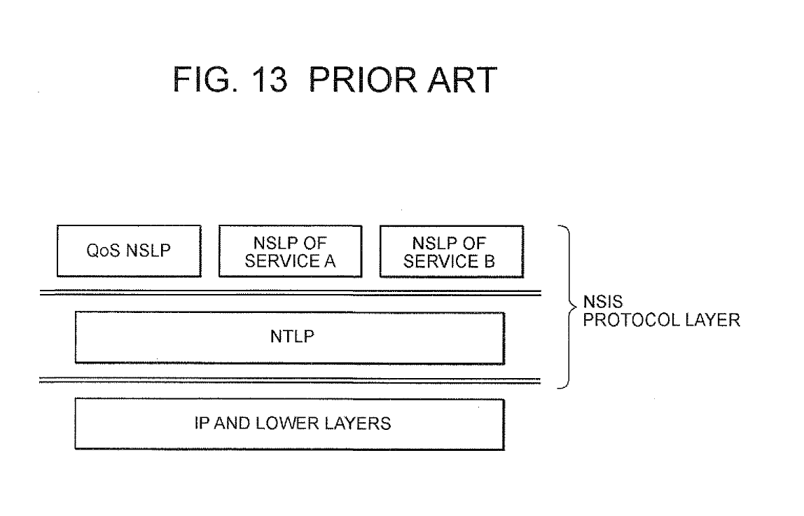

FIG. 14 is a schematic diagram explaining a concept in which an NE and a QNE that are NSIS nodes are “adjacent” according to the conventional technology;

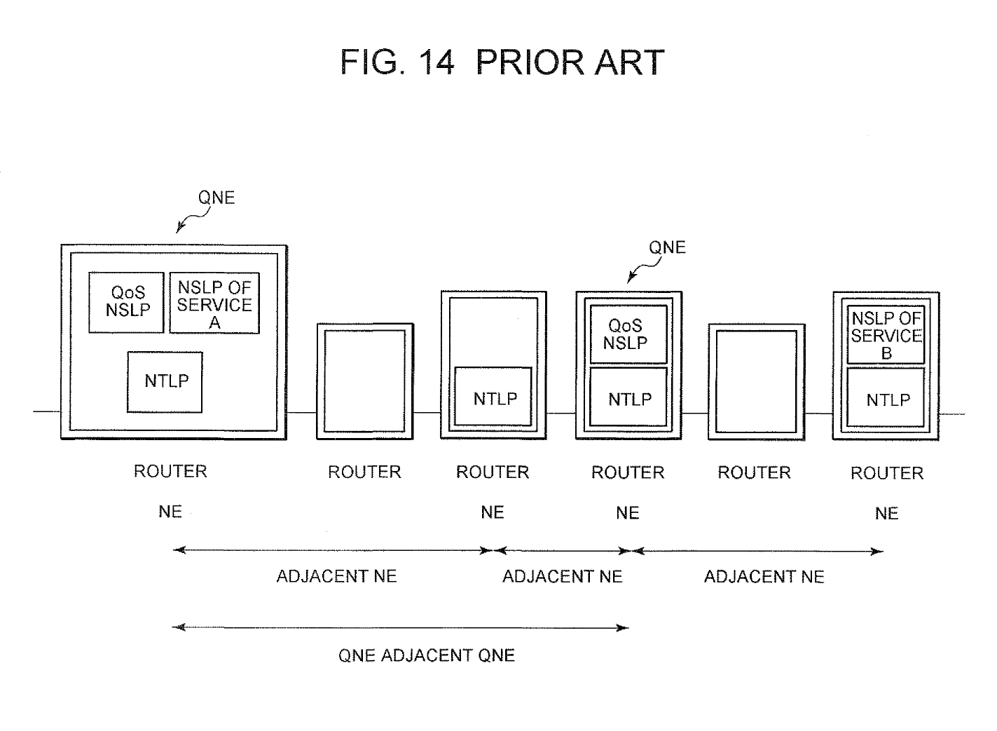

FIG. 15 is a schematic diagram showing how a QoS resource reservation is performed in the NSIS in the conventional technology;

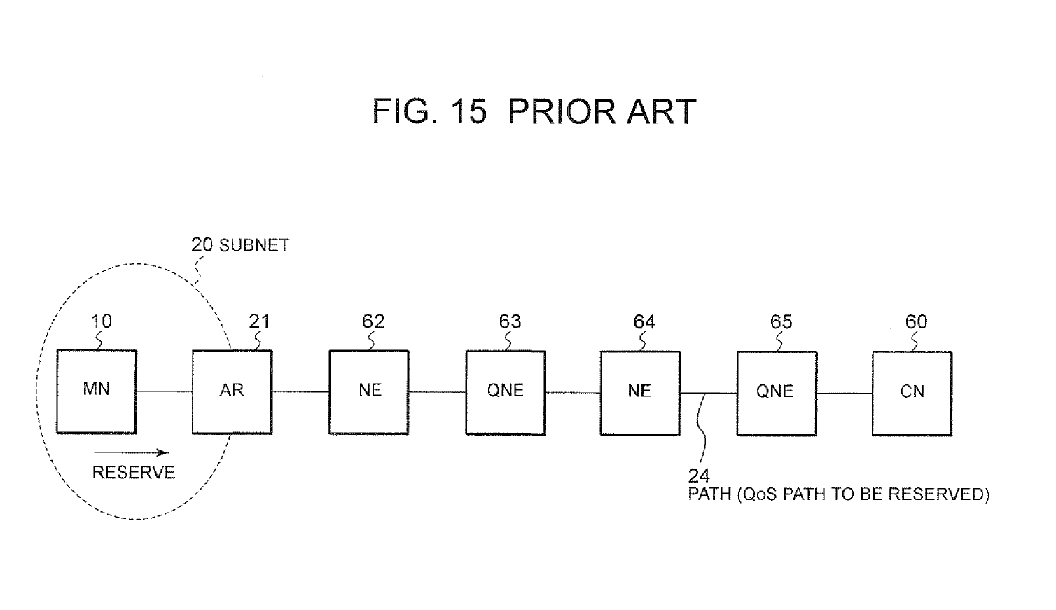

FIG. 16 is a schematic diagram explaining how a double resource reservation is avoided in the NSIS in the conventional technology; and

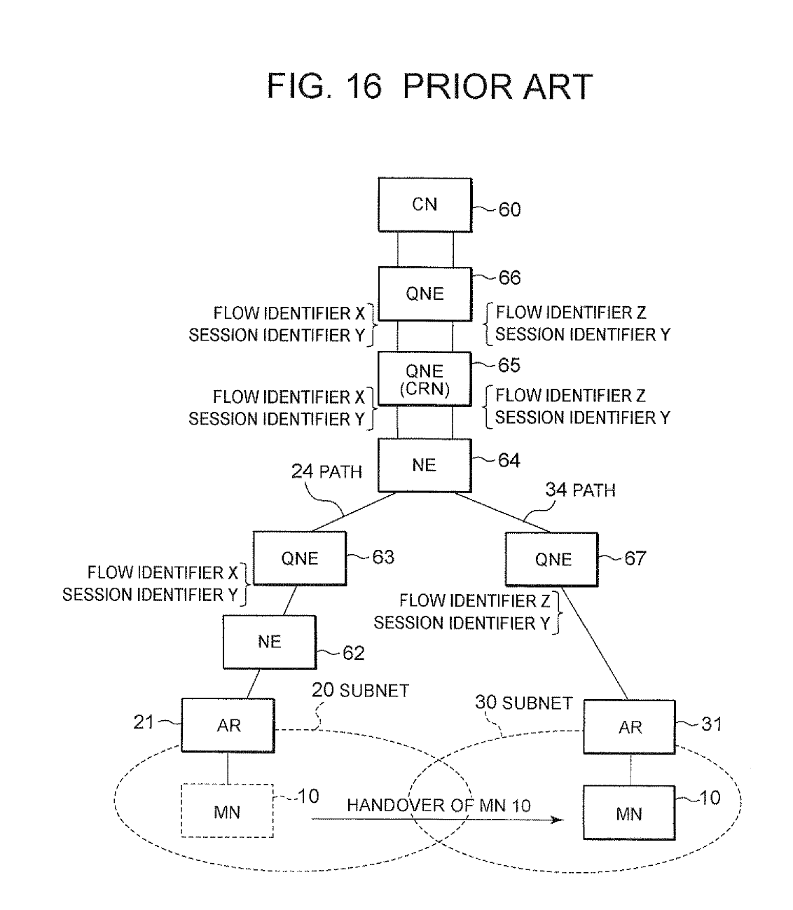

FIG. 17 is a schematic diagram explaining an example of a nested aggregation reservation when the communication network is in a nested state.

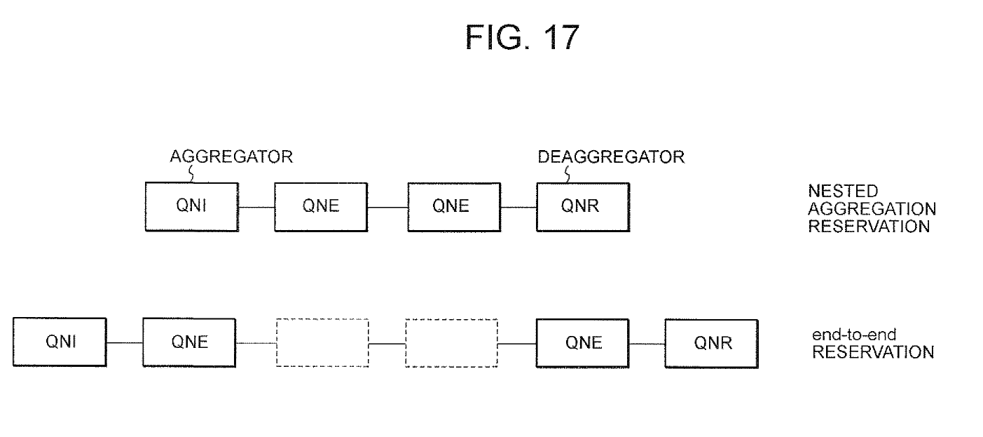

### BEST MODE OF CARRYING OUT THE INVENTION

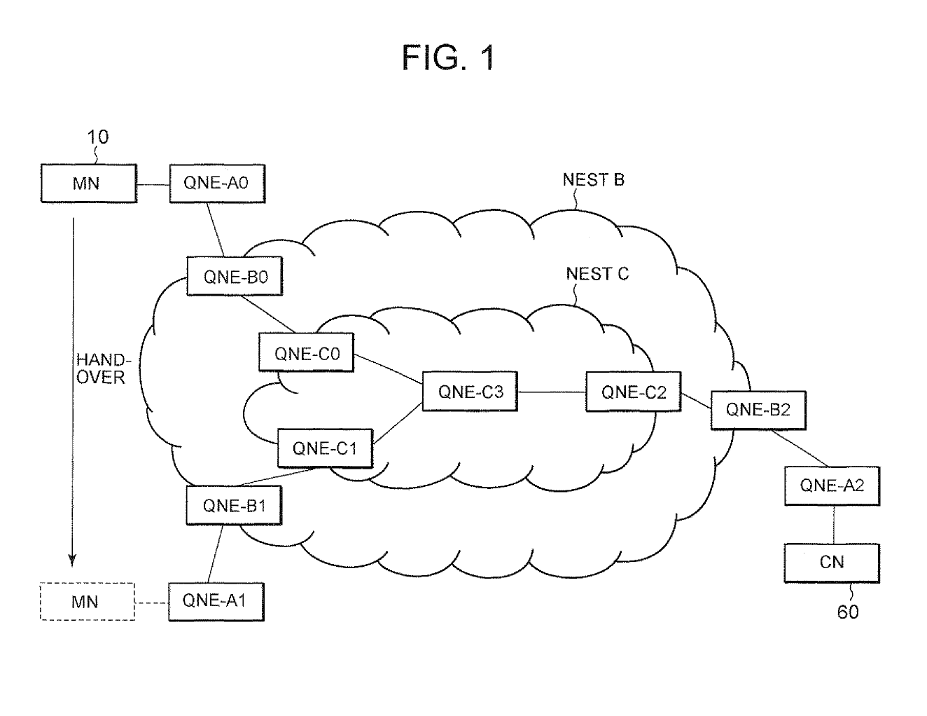

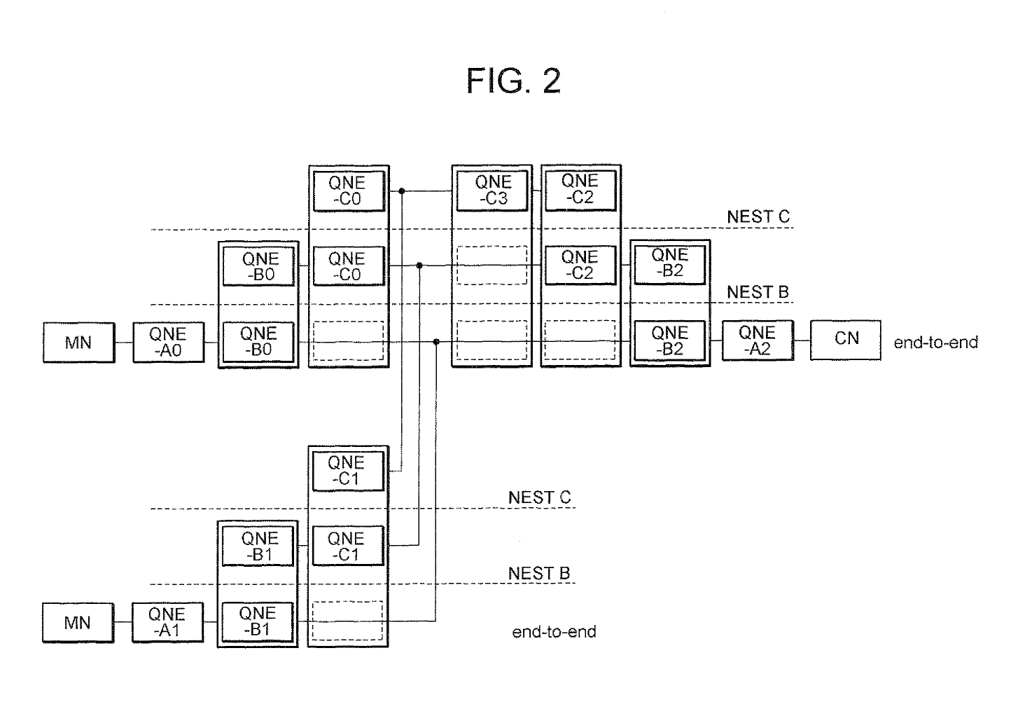

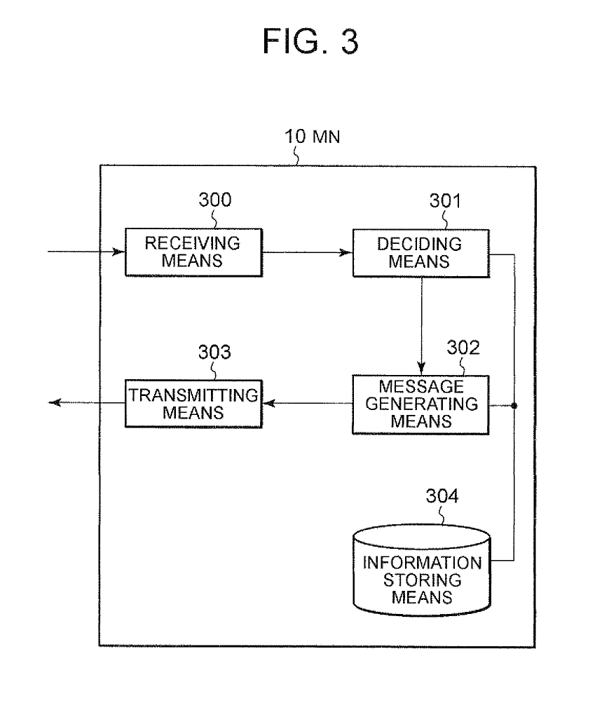

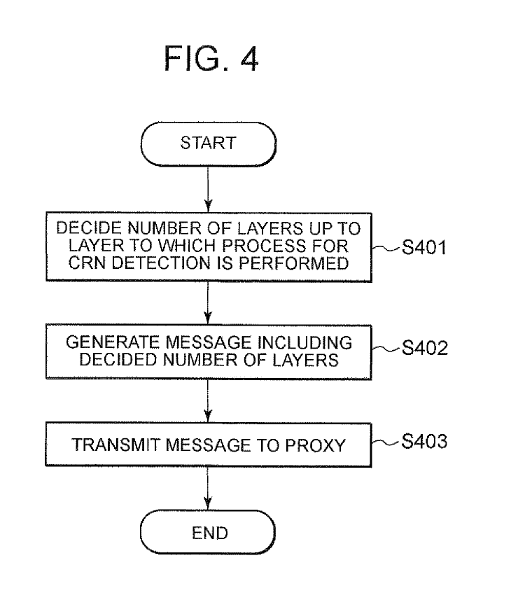

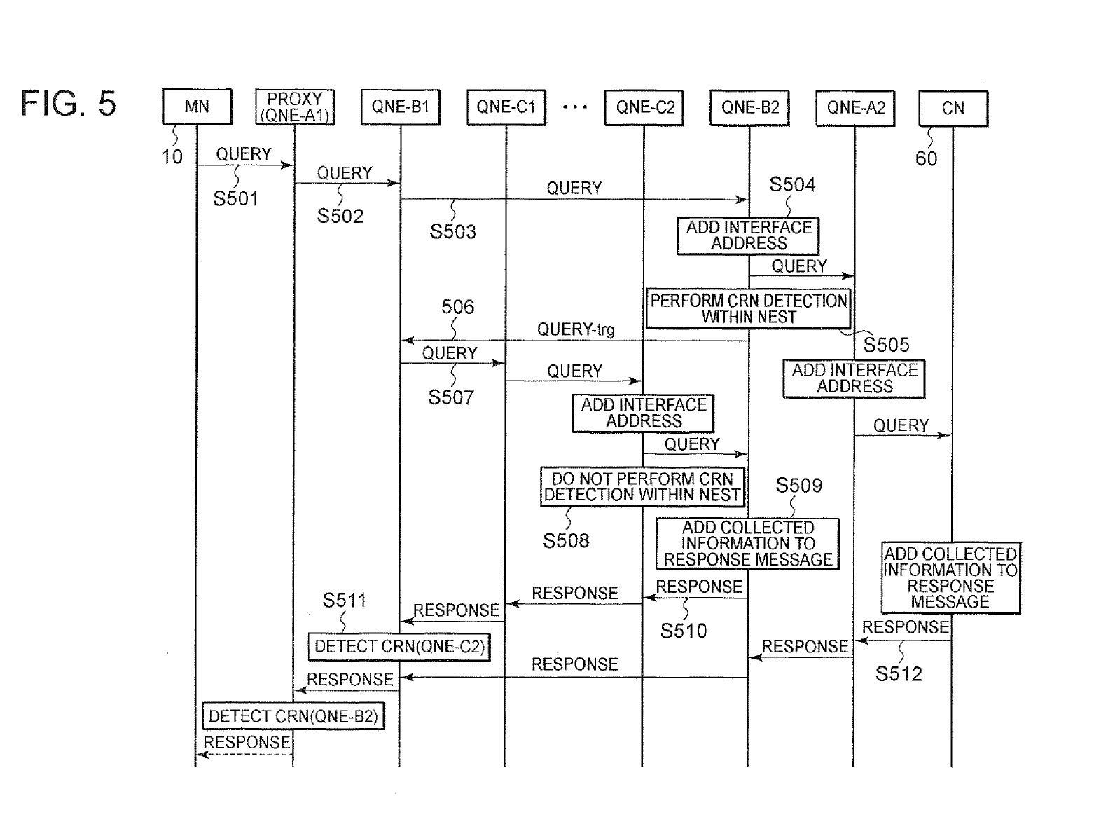

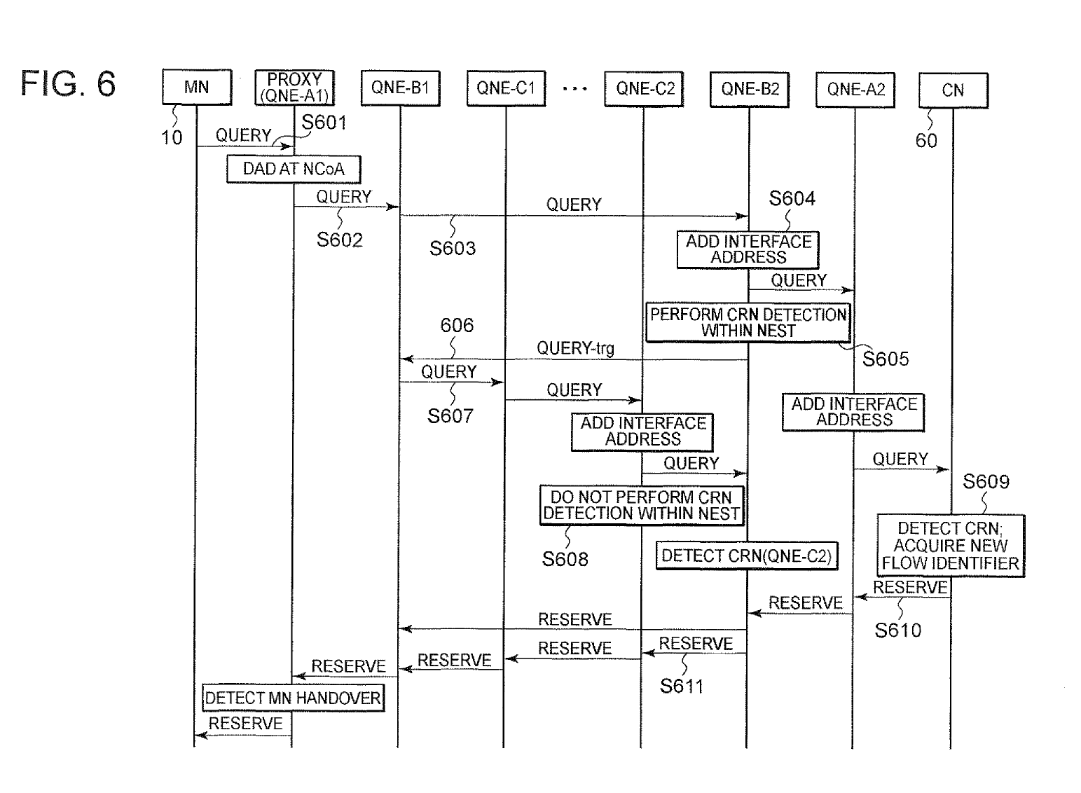

Hereinafter, an embodiment of the present invention will be described with reference to FIG. 1 to FIG. 10. FIG. 1 is a schematic diagram of a configuration of a communication network according to an embodiment of the invention. FIG. 2 is a schematic diagram of a nested aggregation reservation in the communication network according to the embodiment of the invention. FIG. 3 is a schematic diagram of a configuration of a mobile node according to the embodiment of the invention. FIG. 4 is a flowchart explaining a flow of a crossover node detection pre-processing according to the embodiment of the invention. FIG. 5 is a sequence chart explaining an example of a CRN detection in a new upstream link path according to the embodiment of the invention. FIG. 6 is a sequence chart explaining an example of a state reservation procedure using QUERY and RESERVE messages according to the embodiment of the invention.

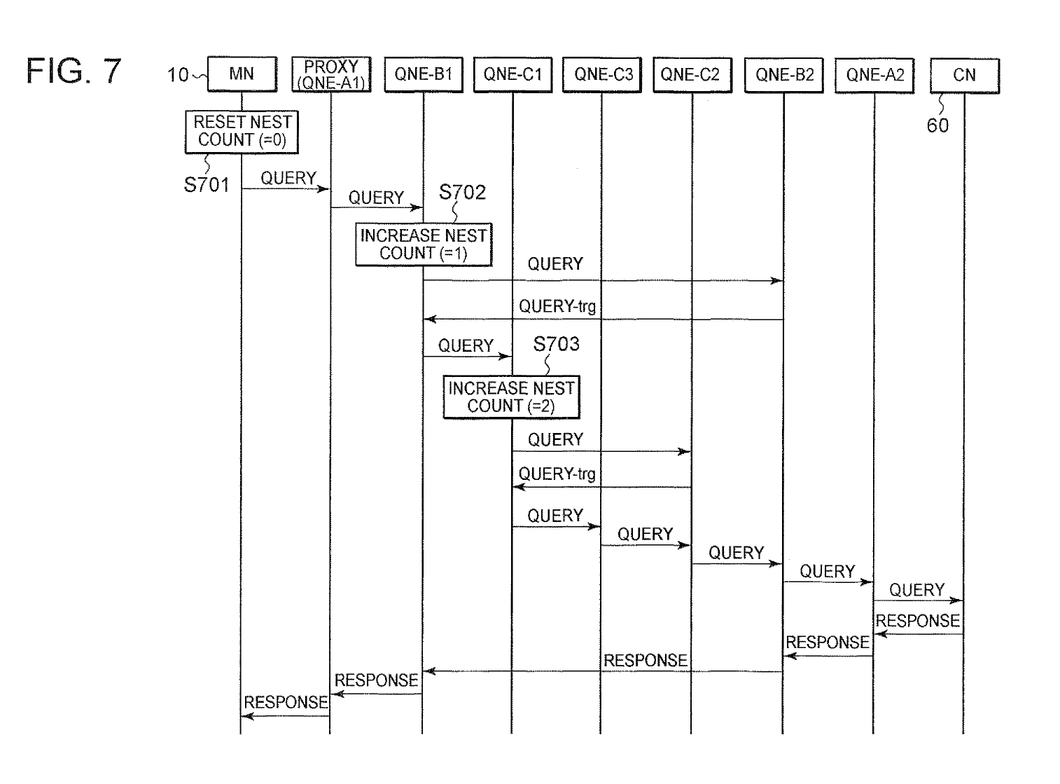

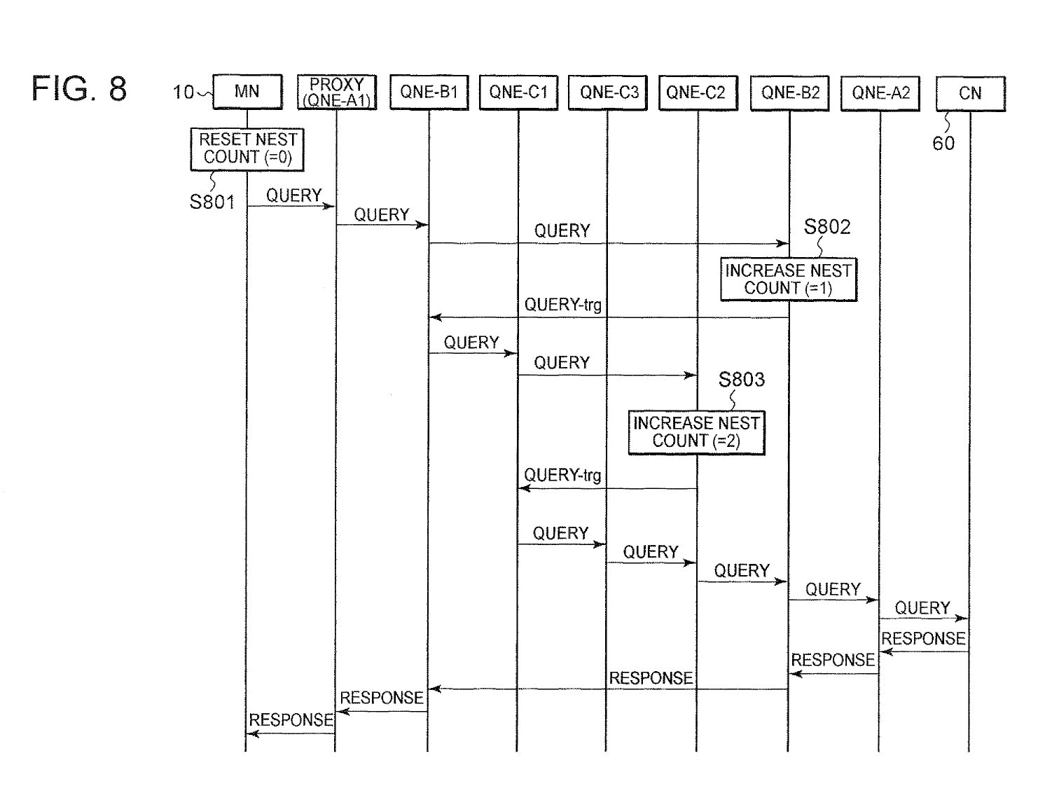

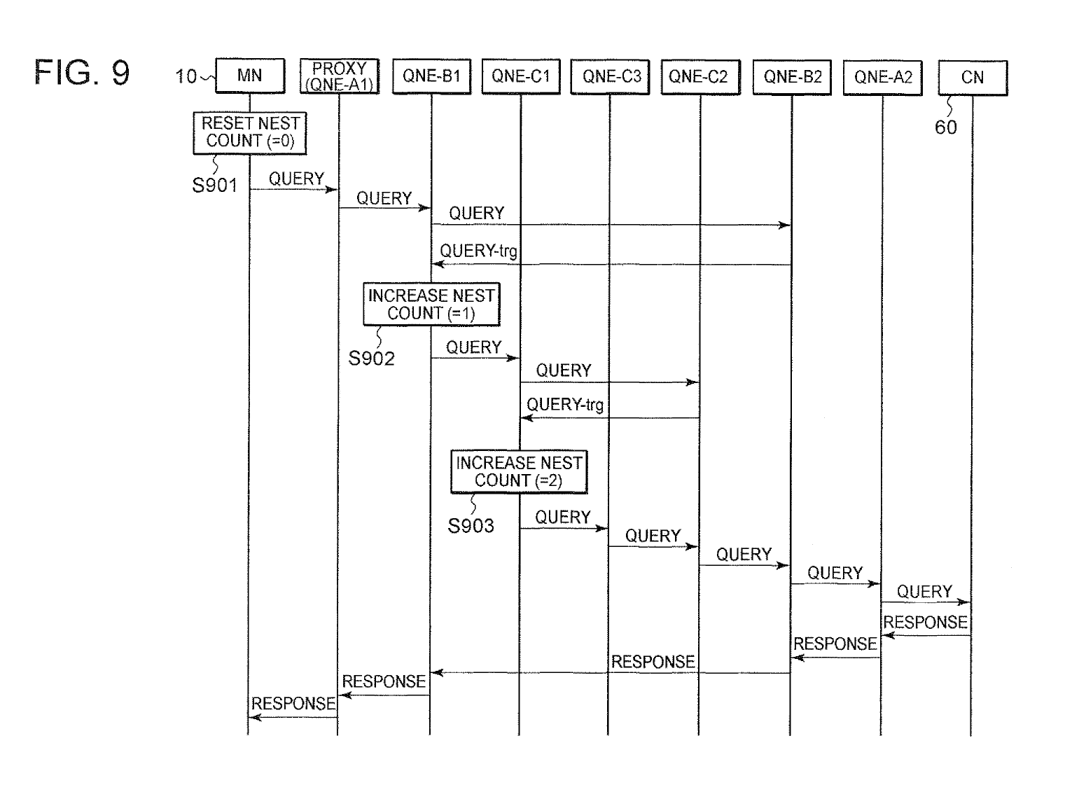

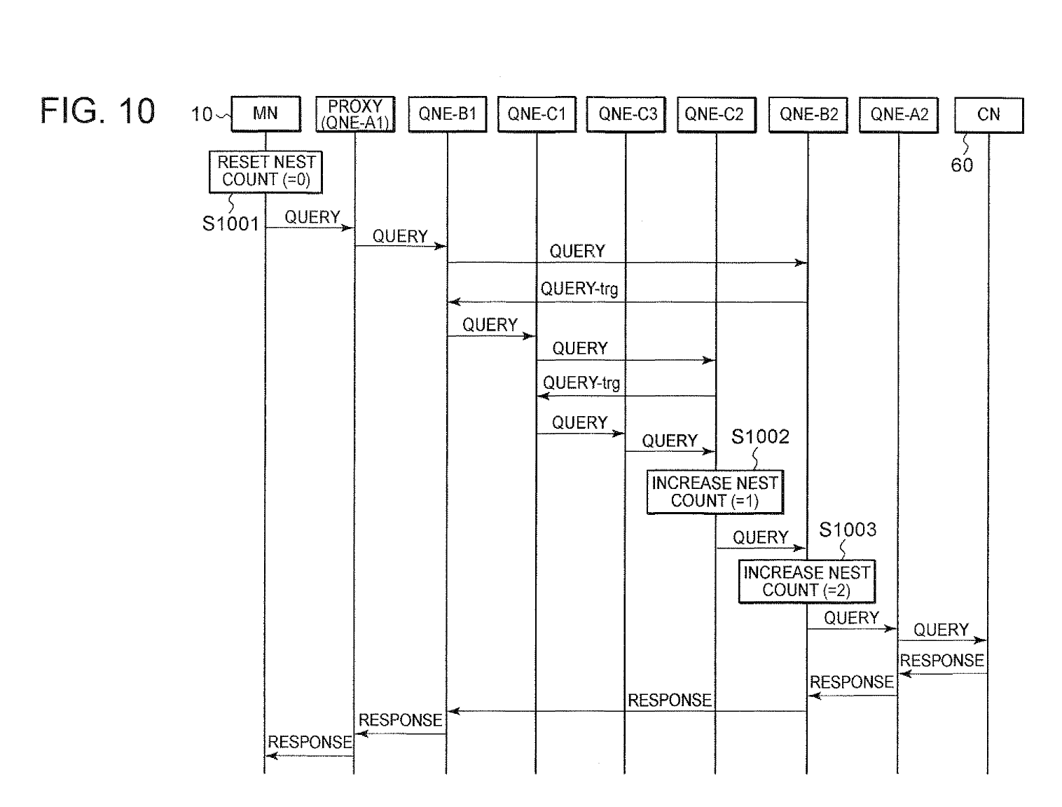

FIG. 7 is a sequence chart explaining an example of a method of detecting the number of layers in the communication network according to the embodiment of the invention. FIG. 8 is a sequence chart explaining an example of another method of detecting the number of layers in the communication network according to the embodiment of the invention. FIG. 9 is a sequence chart explaining an example another method of detecting the number of layers in the communication network according to the embodiment of the invention. FIG. 10 is a sequence chart explaining an example of another method of detecting the number of layers in the communication network according to the embodiment of the invention.

First, a configuration of the communication network according to the embodiment of the invention will be described with reference to FIG. 1. As shown in FIG. 1, the communication network between an MN 10 and a CN 60 is configured by a plurality of layers (also referred to here as a nest) that are nested. In FIG. 1, the communication network is configured by three layers (end-to-end, nest B, and nest C). FIG. 2 shows an aspect of the configuration. A QNE-B0, a QNE-B1, and a QNE-B2 are in positions equivalent to an aggregator/deaggregator in the nest B. A QNE-C0, a QNE-C1, and a QNE-C2 are in positions equivalent to an aggregator/deaggregator in the nest C. In this case, the actual CRN is QNE-C3.

Currently, the MN 10 is communicating with the CN 60 along a path before a handover (QNE-A to QNE-B0 to QNE-C0 to QNE-C3 to QNE-C2 to QNE-B2 to QNE-A2). When the MN 10 performs the handover, the MN 10 communicates with the CN 60 along a new path (QNE-A1 to QNE-B1 to QNE-C1 to QNE-C3 to QNE-C2 to QNE-B2 to QNE-A2). A reservation state at the end-to-end is respectively QNE-A0, QNE-B0, QNE-B2, and QNE-A2 before the handover and QNE-A1, QNE-B1, QNE-B2, and QNE-A2 after the handover. When the CRN detection is performed in the end-to-end, the QNE-B2 is detected as the CRN. In this case, a double reservation occurs between the QNE-B2 and the actual CRN (QNE-C3).

When the MN 10 decides to further perform the CRN detection, the detection process is also performed in the nest B. The reservation state is respectively QNE-B0 QNE-C0-QNE-C2, and QNE-B2 before the handover and QNE-B1, QNE-C1, QNE-C2, and QNE-B2 after the handover. In this case, the QNE-C2 is detected as the CRN. Double reservation occurs between QNE-C2 and the actual CRN (QNE-C3). The detection process is required to be performed up to the nest C to detect the actual CRN (QNE-C3). The reservation state at this time is respectively QNE-C0, QNE-C3, and QNE-C2 before the handover and QNE-C1, QNE-C3, and QNE-C2 after the handover. Therefore, the QNE-C3 is detected as the CRN and the QNE-C3 becomes the actual CRN. As a result, in the embodiment, the CRN detection process is required to be repeated three times. The number of times the CRN detection process is repeated is decided by the MN 10 or the communication network side (for example, a managing device that manages the communication network) based on communication network resources, a communication network policy, a QoS request, and the like. Information on the decided number of times is included in an initial signaling for CRN detection.

Next, a configuration of a mobile node (MN 10) according to the embodiment of the invention will be described with reference to FIG. 3. In FIG. 3, each function of the MN 10 is shown by a block. These functions can be actualized by hardware or software, or both hardware and software. As shown in FIG. 3, the MN 10 includes a receiving means 300, a deciding means 301, a message generating means 302, a transmitting means 303, and an information storing means 304. The receiving means 300 receives, for example, messages, data, and the like transmitted from the CN 60 that is a communication partner of the MN 10 itself. The transmitting means 303 transmits, for example, messages generated by the message generating means 302, described hereafter, other data, and the like.

The deciding means 301 decides a layer, among the plurality of layers that are overlapped such as to be nested similar to the communication network shown in FIG. 1, up to which the process for CRN detection is performed. The deciding means 301 also decides the number of layers from an outermost layer of the plurality of layers (end-to-end in FIG. 1) to the decided layer (hereafter, also referred to as the number of layers up to the layer to which the process for CRN detection is performed). The deciding means 301 decides the number of layers from the outermost layer of the plurality of layers to the decided layer based on, for example, communication network resources, a communication network policy, and information on a QoS request. Rather than the deciding means 301 deciding the number of layers from the outermost layer of the plurality of layers to the decided layer, a managing device (not shown) on a side managing the communication network, for example, can make the decision instead.

The message generating means 302 generates a message including information on the decided number of layers. The generated message can include, for example, identifying information for identifying the MN 10 and timeout information, in addition to the information on the decided number of layers. Here, the timeout information refers to time at which the process for CRN detection is forcibly terminated even when the process has not been performed up until the decided layer. The timeout information is, for example, 30 seconds from the start of the process. As a result of the timeout information being set, a delay in the QoS handover caused by time-consuming CRN detection can be resolved. Rather than detection of the number of layers up to the layer to which the process for CRN detection is performed, a message can be generated to which only the timeout information is inserted, without inserting the number of layers up to the layer to which the process for CRN detection is performed.

Next, the flow of the crossover node detection pre-processing according to the embodiment of the invention will be described with reference to FIG. 4. First, when the MN 10 performs a handover from the QNE-A0 to which the MN 10 is currently connected and connects to the QNE-A1, the MN 10 decides the number of layers up to the layer to which the process for CRN detection is performed, based on information such as, for example, communication network resources, a communication network policy, and information on a QoS request (Step S401). The MN 10 generates a message including information on the decided number of layers (Step S402). Then, the MN 10 transmits the generated message to a new access router (NAR) (Step S403). The NAR is, for example, of a subnet that is a new connection destination having a QNE function and serves as a proxy in the CRN detection process. Rather than the MN 10 deciding the number of layers up to the layer to which the process for CRN detection is performed, a managing device (not shown) that manages the communication network can make the decision and transmit the message to the NAR.

As a result of the number of layers up to the layer to which the process for CRN detection is performed being decided and the decided number of layers being transmitted to the NAR, the process for CRN detection is started based on the number of layers received by the NAR. The method for detecting the CRN is not limited to one method. Various methods can be used for the detection. Hereafter, a method described in QoS Mobility Support with Proxy-assisted Fast Crossover Node Discovery, shown in Non-Patent Document 12 and presented in September 2004 at an international assembly called The Seventh International Symposium on WIRELESS PERSONAL MULTIMEDIA COMMUNICATIONS (WPMC 2004), is given as an example of a method of CRN detection and described.

Here, an example of a procedure for CRN detection using an extended QoS NSLP message will be described with reference to FIG. 5. FIG. 5 is a sequence chart of a CRN detection in a new upstream link path. The sequence chart in FIG. 5 is based on the communication network in FIG. 1, described above. The explanation is made with the QNE-A1 as the proxy. First, the MN 10 transmits the QUERY (message) to the QNE-A11 (also referred to, hereinafter, as the proxy) (Step S501). At this time, a message (also referred to, hereinafter, as a message A) including the above-described number of layers is also transmitted to the proxy. At this time, the MN 10 requests that the proxy collect resource information along the new upstream link path before the actual handover. In addition to conventional parameters, the QUERY message includes the current flow identifier and the session identifier in the upstream link (from the MN 10 to the CN 60) and the downstream link (from the CN 60 to the MN 10).

Then, upon receiving the QUERY message from the MN 10, the proxy transfers the QUERY message to the CN 60 (Step S502). At this time, the message A is also transferred as is the QUERY message. The information on the number of layers can be included in the QUERY message. The IP address of the CN 60 is included in the flow identifier. A QNE positioned in the end-to-end layer of the upstream link acquires the QUERY message and the message A and adds information to the QUERY message stating that the resource can be used. The QNE transfers the QUERY message and the message A based on the information on the number of layers included in the message A (Step S503). At the same time, each QNE checks whether a pair, composed of the flow identifier and the session identifier in the QUERY message, matches a reservation state present on the upstream link. When there is a match, the QNE adds the IP address of the interface to the QUERY message (Step S504). When the QUERY message and the message A reaches the CN 60, the QUERY message includes the IP addresses of the interfaces that are overlapping between the current upstream link path (from the MN 10 to the CN 60) and the new upstream link path (from the proxy to the CN 60) in the end-to-end layer.

Here, when the information on the number of layers included in the message A is the information stating that the CRN detection up to the nest B will be performed, shown in FIG. 1, is considered. At this time, the QNE-B1 adds information to the QUERY message stating that the resource can be used. The QNE-B1 transfers the QUERY message and the message A based on the information on the number of layers included in the message A. Then, the transferred QUERY message and message A reach the QNE-B2. The QNE-B2 adds information stating that the resource can be used and the IP address of the interface to the QUERY message and transfers the message upstream. At the same time, the QNE-B2 decides to perform the CRN detection within the nest B, based on the information on the number of layers included in the message A (Step S505). The QNE-B2 transmits a message for starting the process towards the QNE-B1 (Step S506).

The message (QUERY-trg) includes the flow identifier and the session identifier established between the QNE-B0 and the QNE-B2 as information required for the CRN detection within the nest B. The message A is also similarly transmitted. The information on the number of layers included in the message A can be included in the QUERY-trg message. The QNE-B1 that has received the QUERY-trg message and the message A transfers the QUERY message including the identifier information and the information on the number of layers towards the QNE-B2 in the nest B layer (Step S507). In the nest B layer, the pair composed of the flow identifier and the session identifier match at the QNE-C2. Therefore, the QNE-C2 adds information stating that the resource can be used and the IP address of the interface to the QUERY message and transfers the message upstream link.

At the same time, the QNE-C2 decides not to perform the CRN detection within the nest C based on the information on the number of layers included in the message A (Step S508). The QNE-B2 that has received the QUERY message in the nest B layer adds the information stating that the resource can be used and the IP address within the QUERY message to the RESPONSE message (Step S509). The QNE-B2 transmits the RESPONSE message to the QNE-B1 (Step S510). The RESPONSE message is transmitted to the QNE-B1 along a path in an opposite direction of the QUERY message in the nest B layer. Upon receiving the RESPONSE message, the QNE-B1 extracts the first IP address to be added from the information on the added IP addresses, thereby detecting the CRN in the nest B layer (QNE-C2) (Step S511).

The same process is performed in the end-to-end layer as well. Upon receiving the QUERY message, the CN 60 transmits the RESPONSE message to the proxy (Step S512). The RESPONSE message includes the collected pieces of information stating that the resource can be used and information on the IP addresses added to the QUERY message in the upstream link. The RESPONSE message is transmitted to the proxy along a path in an opposite direction of the QUERY message. Upon receiving the RESPONSE message, the proxy extracts the first IP address to be added from the information on the added IP addresses, thereby detecting the CRN of the upstream link (QNE-B2). The proxy can also acquire the collected pieces of information stating that the resource can be used on the new upstream link path.

Simultaneously with the transmission of the RESPONSE message, the CN 60 transmits the QUERY message and the message A to the proxy in the end-to-end layer. The QUERY message includes the current flow identifier and the session identifier in the downstream link. The current flow identifier and the session identifier are extracted from the upstream link QUERY message. By the same method as that for the upstream link, each QNE on the downstream link signaling path acquires the QUERY message and adds information stating that the resource can be used. The QUERY message and the message A are transferred based on the information on the number of layers included in the message A. At the same time, each QNE checks whether the pair, composed of the flow identifier and the session identifier in the QUERY message, matches the reservation state present in the downstream link.

When there is a match, the QNE adds the IP address of the interface to the QUERY message. When the QUERY message reaches the proxy, the QUERY message includes the IP addresses of the interface that are overlapping between the current downstream link path (from the CN 60 to the MN 10) and the new downstream link path (from the CN 60 to the proxy) in the end-to-end layer. The proxy extracts the last IP address to be added from the information on the added IP addresses, thereby detecting the CRN of the downstream link. The proxy can also acquire the collected pieces of information stating that the resource can be used on the new downstream link path. The CRN detection in the nest B layer in the downstream link can be considered in the same manner as the CRN detection in the upstream link.

The proxy holds the information on the CRN and information stating that the resource can be used in the actual reservation after the handover for the end-to-end layer. The proxy can transmit the RESPONSE message to the MN 10 such that the MN 10 can use the information stating that the resource can be used by the handover destination being decided. The QNE-B1 holds the information on the CRN and information stating that the resource can be used in the actual reservation after the handover for the nest B layer.

The above-described method is a procedure (method) for CRN detection performed before the handover. In the above-described method, the proxy and the CN 60 can start the reservation simultaneously with the CRN detection. Hereafter, an example of a state reservation procedure using the QUERY message and the RESERVE message will be described with reference to FIG. 6. FIG. 6 is a sequence chart explaining an example of a state reservation procedure in the new upstream link path. First, the MN 10 transmits the QUERY message to the proxy using the above-described method (Step S601). At this time, the QUERY message includes the NCoA used at the handover destination. As in the above-described method, the message A including the information on the number of layers is also transmitted to the proxy.

The proxy performs a duplicate address detection (DAD) at the received NCoA. When the detection is passed (no problems are present), the proxy includes information on the NCoA to the QUERY message and transmits the QUERY message towards the CN 60 (Step S602). Each QNE uses the same method as the above-described CRN detection. The CN 60 detects the CRN (QNE-B2) of the upstream link in the end-to-end layer from the QUERY message, and a new flow identifier for making the reservation is acquired from the NCoA (Step S609). Similarly, the QNE-B2 detects the CRN (QNE-C2) of the upstream link in the nest B layer. The CN 60 transmits the RESERVE message instead of the RESPONSE message in the end-to-end layer, along a path in the opposite direction of the QUERY message (Step S610). Upon receiving the RESERVE message, the QNE-B2 transmits the RESERVE message for the end-to-end layer to the QNE-B1 and transmits the RESERVE message for the nest B layer towards the QNE-B1.

The QNE of which the interfaces are overlapping (in other words, from the CN 60 to the QNE-B2 that is the CRN in the end-to-end layer or from the QNE-B2 to the QNE-C2 that is the CRN in the nest B layer) updates the reservation state to prevent double reservation. Other QNE on the new upstream link path (from the QNE-B2 that is the CRN to the proxy in the end-to-end layer or from the QNE-C2 that is the CRN to the QNE-B1 in the nest B layer) generate new reservation states. Update and generation of reservation states can be performed in this way by the same method in the new downstream link path as well. When the MN 10 actually performs the handover, a new reservation state is generated between the MN 10 and the proxy. As a result, a new end-to-end QoS path is established.

Here, four methods of detecting the number of layers (also referred to as the number of nests) in the communication network that is a base for when the MN 10 or the managing device (not shown) on the communication network managing side decides the number of layers up to the layer to which the process for CRN detection is performed will be described, hereafter.

A first method is that in which the number of layers is counted when the aggregator receives a QUERY. The method will be described in detail with reference to FIG. 7. The QUERY (QUERY message) in the four detection methods described hereafter includes a nest count indicating the number of counted nests (in other words, a nest count indicating the number of upper network layers). The QUERY herein is equivalent to the above-described layer number detection message. The message is generated by the message generating means 302 of the MN 10 and is transmitted by the transmitting means 303. As shown in FIG. 7, the MN 10 (for example, the message generating means 302) resets the nest count (nest count=0) (Step S701). The MN 10 transmits the QUERY with the reset nest count to the proxy (QNE-A1). The proxy that has received the QUERY transfers the QUERY to the QNE-B1. The QNE-B1 that is the aggregator of the nest B counts upwards such that nest count=1 (Step S702). In other words, the value of the nest count is increased by 1.

The QNE-B1 transfers the QUERY that has been counted upwards to the QNE-B2. The QNE-B2 that has received the QUERY transmits the QUERY-trg to the QNE-B1 in response to the QUERY. The QNE-B1 that has received the QUERY-trg transmits the QUERY to the QNE-C1 to detect whether further nests are present. The QNE-C2 that is the aggregator of the nest C and that has received the QUERY counts upwards such that the nest count=2 (Step S703). The QNE-C1 transfers the QUERY that has been counted upwards to the QNE-C2. The QNE-C2 that has received the QUERY transmits the QUERY-trg to the QNE-C1 as in response to the QUERY. The QNE-C1 that has received the QUERY-trg transmits the QUERY to the QNE-C3 to detect whether further nests are present.

In this example, the QNE-C3 is within the nest C and transfers the QUERY to the QNE-C2. The QNE-C2 transfers the received QUERY towards the CN 60. Then, the CN 60 that has received the QUERY transmits, for example, a RESPONSE (RESPONSE message) including information on the number of counted nests towards the MN 10. As a result, the MN 10 can detect the number of layers in the communication network. At this time, the RESPONSE request for the QUERY is added only the QUERY of the uppermost layer. This also applies to the three detection methods described hereafter.

A second method is that in which the number of layers is counted when the deaggregator receives the QUERY. The method will be described in detail with reference to FIG. 8. As shown in FIG. 8, the MN 10 resets the nest count (nest count=0) (Step S801). The MN 10 transmits the QUERY with the reset nest count to the proxy (QNE-A1). The proxy that has received the QUERY transfers the QUERY to the QNE-B1. The QNE-B1 transfers the received QUERY to the QNE-B2. The QNE-B2 that is the deaggregator of the nest B and that has received the QUERY counts upwards such that nest count=1 (Step S802).

The QNE-B2 transmits the QUERY-trg including the information on the nest count to the QNE-B1 in response to the received QUERY. The QNE-B1 that has received the QUERY-trg transmits the QUERY including the information on the nest count to the QNE-C1. The QNE-C1 that is positioned on the edge of the nest C and that has received the QUERY transfers the QUERY to the QNE-C2. The QNE-C2 that is the deaggregator of the nest C and that has received the QUERY counts upwards such that the nest count=2 (Step S803). The QNE-C2 that has received the QUERY transmits the QUERY-trg to the QNE-C1 in response to the QUERY. The QNE-C1 that has received the QUERY-trg transmits the QUERY to the QNE-C3 to detect whether further nests are present.

In this example, the QNE-C3 is within the nest C and transfers the QUERY to the QNE-C2. The QNE-C2 transfers the received QUERY towards the CN 60. Then, the CN 60 that has received the QUERY transmits, for example, a RESPONSE including information on the number of counted nests towards the MN 10.

A third method is that in which the number of layers is counted when the aggregator receives the QUERY-trg. The method will be described in detail with reference to FIG. 9. As shown in FIG. 9, the MN 10 resets the nest count (nest count=0) (Step S901). The MN 10 transmits the QUERY with the reset nest count to the proxy (QNE-A1). The proxy that has received the QUERY transfers the QUERY to the QNE-B1. The QNE-B1 transfers the received QUERY to the QNE-B2. The QNE-B2 that has received the QUERY transmits the QUERY-trg to the QNE-B1 in response to the QUERY.

The QNE-B1 that is the aggregator of the nest B and that has received the QUERY-trg counts upwards such that the nest count=1 (Step S902). Then, the QNE-B1 transmits the QUERY to the QNE-C1 of the nest C. The QNE-C1 transfers the received QUERY to the QNE-C2. The QNE-C2 transmits the QUERY-trg to the QNE-C1 in response to the QUERY. The QNE-C1 that is the aggregator of the nest C and that has received the QUERY-trg counts upwards such that the nest count=2 (Step S903). The QNE-C1 transmits the QUERY to the QNE-C3 to detect whether further nests are present.

In the example, the QNE-C3 is within the nest C and transfers the QUERY to the QNE-C2. The QNE-C2 transfers the received QUERY towards the CN 60. Then, the CN 60 that has received the QUERY transmits, for example, a RESPONSE including the information on the counted number of nests towards the MN 10.

A fourth method is that in which the number of layers is counted when the deaggregator receives an internal QUERY corresponding to the QUERY-trg. The method will be described in detail with reference to FIG. 10. As shown in FIG. 10, the MN 10 resets the nest count (nest count=0) (Step S1001). The MN 10 transmits the QUERY with the reset nest count to the proxy (QNE-A1). The proxy that has received the QUERY transfers the QUERY to the QNE-B1. The QNE-B1 transfers the received QUERY to the QNE-B2. The QNE-B2 that has received the QUERY transmits the QUERY-trg to the QNE-B1 in response to the QUERY.

The QNE-B1 that has received the QUERY-trg transmits the QUERY to the QNE-C1 that is the aggregator of the nest C to detect the nest. The QNE-C1 transfers the received QUERY to the QNE-C2. The QNE-C2 transmits the QUERY-trg to the QNE-C1 in response to the QUERY. The QNE-C1 that has received the QUERY-trg transmits the QUERY to the QNE-C3 to detect the nest. The QNE-C3 that has received the QUERY is within the nest C and transfers the QUERY to the QNE-C2.

The QNE-C2 that is the deaggregator of the nest C and that has received the QUERY counts upwards such that the nest count=1 (Step S1002). Then, the QNE-C2 transmits the QUERY to the QNE-B2 that is the deaggregator of the nest B. The QNE-B2 that has received the QUERY counts upwards such that the nest count=2 (Step S1003). Then, the QNE-B2 transmits the QUERY towards the CN 60. The CN 60 that has received the QUERY transmits, for example, a RESPONSE including the information on the counted number of nest towards the MN 10.

Signaling in these four detection methods can be performed before or after the MN 10 performs the handover. When the signaling is performed before the handover is performed, the proxy is used.

As described above, according to the embodiment of the invention, when the MN performs a handover and detects the CRN, the layer, among the aggregation overlapping such as to be nested (the plurality of layers), up to which the process for detecting the CRN is performed is decided and the number of layers from the outermost layer of the aggregation (the plurality of layers) to the decided layer is decided. As a result, the CRN detection is not time-consuming, double reservation can be kept to a minimum, and QoS failure can be avoided.

Each functional block used in the explanations of each embodiment of the present embodiment, described above, can be actualized as a large scale integration (LSI) that is typically an integrated circuit. Each functional block can be individually formed into a single chip. Alternatively, some or all of the functional blocks can be included and formed into a single chip. Although referred to here as the LSI, depending on differences in integration, the integrated circuit can be referred to as the integrated circuit (IC), a system LSI, a super LSI, or an ultra LSI. The method of forming the integrated circuit is not limited to LSI and can be actualized by a dedicated circuit or a general-purpose processor. A field programmable gate array (FPGA) that can be programmed after LSI manufacturing or a reconfigurable processor of which connections and settings of the circuit cells within the LSI can be reconfigured can be used. Furthermore, if a technology for forming the integrated circuit that can replace LSI is introduced as a result of the advancement of semiconductor technology or a different derivative technology, the integration of the functional blocks can naturally be performed using the technology. For example, the application of biotechnology is a possibility.

### INDUSTRIAL APPLICABILITY

In the crossover node detection pre-processing method, the crossover node detection pre-processing program for executing this method by a computer, and the mobile node used in this method of the present invention, when a handover is performed and the CRN is detected, the network layer, among the aggregation overlapping such as to be nested (the plurality of network layers), up to which the process for detecting the CRN is performed is decided and the number of layers from the outermost network layer of the aggregation (the plurality of network layers) to the decided network layer is decided. As a result, the CRN detection is not time-consuming, double reservation can be kept to a minimum, and QoS failure can be avoided. Therefore, the crossover node detection pre-processing method, the crossover node detection pre-processing program for executing this method by a computer, and the mobile node used in this method of the present invention relate to a crossover node detection pre-processing method, a crossover node detection pre-processing program for executing this method by a computer, and a mobile node used in this method, in which the crossover node detection pre-processing method is used in a handover of a mobile node performing wireless communication. The crossover node detection pre-processing method, the crossover node detection pre-processing program for executing this method by a computer, and the mobile node used in this method of the present invention are particularly advantageous for a crossover node detection pre-processing method, a crossover node detection pre-processing program for executing this method by a computer, and a mobile node used in this method, in which the crossover node detection pre-processing method is used in a handover of a mobile node performing wireless communication using mobile Internet Protocol version 6 (IPv6), which is a next-generation Internet protocol.

1. A crossover node detection pre-processing method for acquiring, in a communication system in which a plurality of access routers, each forming a subnet, are connected via a communication network configured such that a plurality of network layers are overlapped such as to be nested and at least one access point forming a fixed communicable area is connected to each of the plurality of access routers, when a mobile node configured such as to communicate, by wireless communication with the access point within the communicable area, with the access router to which the access point is connected switches connection from a currently communicating access point to another access point as a result of handover, information required to detect a crossover node at which a new communication path and an old communication path in the communication network converge and separate, the crossover node detection pre-processing method comprising the steps of:
deciding, by the mobile node, a network layer, among the plurality of network layers overlapped such as to be nested, up to which a process for detecting the crossover node is performed and deciding a number of layers from an outermost network layer of the plurality of network layers to the decided network layer; and
generating a message including information on the decided number of layers.

2. The crossover node detection pre-processing method according to claim 1, wherein the number of layers from the outermost network layer of the plurality of network layers to the decided network layer is decided by a managing device managing the communication network.

3. The crossover node detection pre-processing method according to claim 1, wherein the number of layers from the outermost network layer of the plurality of network layers to the decided network layer is decided based on at least a resource of the communication network, a policy of the communication network, and information on a QoS request.

4. The crossover node detection pre-processing method according to claim 1, wherein:
a number of the plurality of network layers overlapped such as to be nested that is a base when the process for detecting the crossover node is performed is detected based on a layer number detection message of which 1 is added to a nest count value indicating a number of upper network layers included in the layer number detecting message, when an edge node positioned on an edge of each network layer of the plurality of network layers that receives the layer number detection message for detecting the number of the plurality of network layers, transmitted by the mobile node, receives the layer number detection message.

5. A crossover node detection pre-processing program for executing the crossover node detection pre-processing method according to claim 1 by a computer.

6. A mobile terminal used in a crossover node detection pre-processing method for acquiring, in a communication system in which a plurality of access routers, each forming a subnet, are connected via a communication network configured such that a plurality of network layers are overlapped such as to be nested and at least one access point forming a fixed communicable area is connected to each of the plurality of access routers, when the mobile node configured such as to communicate, by wireless communication with the access point within the communicable area, with the access router to which the access point is connected switches connection from a currently communicating access point to another access point as a result of handover, information required to detect a crossover node at which a new communication path and an old communication path in the communication network converge and separate, the mobile terminal comprising:
a deciding means that decides a network layer, among the plurality of network layers overlapped such as to be nested, up to which a process for detecting the crossover node is performed and decides a number of layers froze an outermost network layer of the plurality of network layers to the decided network layer; and
a message generating means that generates a message including information on the decided number of layers.

7. The mobile node according to claim 6, wherein the deciding means decides the number of layers from the outermost network layer of the plurality of network layers to the decided network layer based on at least a resource of the communication network, a policy of the communication network, and information on a QoS request.

8. The mobile node according to claim 6, wherein:
a number of the plurality of network layers overlapped such as to be nested that is a base when the process for detecting the crossover node is performed is detected based on a layer number detection message of which 1 is added to a nest count value indicating a number of upper network layers included in the layer number detecting message, when an edge node positioned on an edge of each network layer of the plurality of network layers that receives the layer number detection message for detecting the number of the plurality of network layers, generated by the message generating means, receives the layer number detection message.
